(19) United States
(12) Patent Application Publication
(10) Pub. No.: US 2017/0275942 A1
(43) Pub. Date: Sep. 28, 2017

(54) CORDLESS ROMAN STYLE SHADE

(71) Applicant: K. E. & KINGSTONE CO., LTD., Taipei (TW)

(72) Inventor: Wen-Chong HUANG, Taipei (TW)

(21) Appl. No.: 15/080,298

(22) Filed: Mar. 24, 2016

(51) Int. Cl. E06B 9/322; E06B 9/262

(52) U.S. Cl. CPC E06B 9/322; E06B 9/262; E06B 2009/2622; E06B 2009/3222

(57) ABSTRACT

A cordless Roman style shade is revealed. The cordless Roman style shade includes at least one piece of middle fabric arranged between a front fabric and a rear fabric. The middle fabric and the rear fabric have the same width. A front end and a rear end of the middle fabric are connected to a rear side of the front fabric and the rear fabric respectively without the use of horizontal rods. The front fabric is driven by the middle fabric to be retracted or extended in the opposite direction when the rear fabric and the middle fabric are retracted and wound around a rotating shaft. Thus the front fabric is retracted or extended horizontally and evenly without the use of the horizontal rods.

### BACKGROUND OF THE INVENTION

Field of the Invention

The present invention relates to a Roman style shade, especially to a cordless Roman style shade in which a front fabric without any horizontal rod is retracted or extended under control of a rear fabric and at least one piece of middle fabric. The width of the rear fabric and the width of the middle fabric are the same.

Descriptions of Related Art

The Roman shade is a common window shade formed by a suspended fabric (hereafter called the “front fabric”) disposed with a plurality of horizontal rods arranged at the fabric with the equal interval. While in use, the horizontal rods are driven by an automatic cord reel or a manually operated cord to retract or extend the front fabric. However, the Roman shade has shortcomings of exposed inner cord, negative effect of the cord on the appearance of the shade, a strangulation hazard to children, etc. In order to overcome the above shortcomings, a cordless curtain with functions of retraction and extension similar to the Roman shade is disclosed, as revealed in US 2011/0088852, U.S. Pat. No. 8,066,050, U.S. Pat. No. 8,668,002 etc.

However, the prior arts mentioned above have the following two shortcomings While in use.

In order to allow soft front fabric foldably retracted or extended horizontally and evenly, the front fabric of the shades revealed in U.S. Pat. No. 8,066,050 (covering portion 51) and U.S. Pat. No. 8,668,002 (blind material 30) are arranged with a plurality of horizontal rods used for supporting the front fabric (such as upper tubes 53 in U.S. Pat. No. 8,066,050 or support rod 311/312 in U.S. Pat. No. 8,668,002). Each horizontal rod made from materials with certain rigidity or support is connected to a rear side of the front fabric. Thus the front fabric is divided into a plurality of foldable fabric parts (such as cloth segment 511, 512, 513 in U.S. Pat. No. 8,066,050). A hollow tubular space is formed on the rear side of the front fabric by sewing and used for mounting the rod. Not only the production cost of the front fabric is increased due to sewing, the production cost of the rods (upper tubes 53 in U.S. Pat. No. 8,066,050 and support rod 311/312 in U.S. Pat. No. 8,668,002) and the cost of assembly are also required. Although the horizontal rods are connected to the rear side of the front fabric, users still can see the horizontal rods through the front side of the front fabric. This seriously affects the appearance of the retracted curtain/shade.

Moreover, the actuating member 411, 412 in U.S. Pat. No. 8,668,002 can be cord, tape, band, a long strip of fabric, etc, as shown in FIG. 1, FIG. 2 and FIG. 7. Thus the horizontal width of the actuating member 411, 412 is limited and is much smaller than the length of the shaft rod 21 in U.S. Pat. No. 8,668,002. During rolling-up of the actuating member 411,412 around the shaft rod 21, the actuating member 411,412 is unable to be wound around the shaft rod 21 continuously and positioned at the same point on the shaft rod 21, especially when the actuating member 411,412 is in the cord form (as shown in FIG. 1, FIG. 2 and FIG. 7). While being around and stacked around the shaft rod 21, the cord is easy to be deviated to the right side or the left side randomly. Thus the soft front fabric (such as blind material 30 in U.S. Pat. No. 8,668,002) is difficult to be retracted or extended horizontally and evenly no matter a single actuating member 411 412 is used to connect to a center of a rear side of the front fabric (such as blind material 30 in U.S. Pat. No. 8,668,002) or two parallel actuating members 411 412 are used to connect to symmetrical positions on the rear side of the front fabric (such as blind material 30 in U.S. Pat. No. 8,668,002) respectively. These result in trouble and inconvenience in operating the fabric/shade.

The shade revealed in U.S. Pat. No. 8,066,050 also has similar shortcomings and problems. Refer to FIG. 3 in U.S. Pat. No. 8,066,050, two parallel and vertical winding pieces 62 with limited width are used to be rolled and wound around a winding rod 61 respectively. Thus the front fabric (such as covering portion 51 or cloth segment 511, 512, 513) in U.S. Pat. No. 8,066,050 is also difficult to be retracted or extended horizontally and evenly.

The front fabric of the prior arts (such as covering portion 51 in U.S. Pat. No. 8,066,050 or blind material 30 in U.S. Pat. No. 8,668,002 all got the problem of maintaining the horizontal position of the front fabric while being retracted. As to US 2011/0088852, it includes a blind body 10 formed by a plurality of honeycomb shaped blind elements. Thus the cost for materials, assembly and production is high and the cord required poses a hazard to kids. In these prior arts, the width of the actuating member 411, 412 in U.S. Pat. No. 8,668,002/the winding piece 62 in U.S. Pat. No. 8,066,050 is much more smaller than the length of the shaft rod 21 in U.S. Pat. No. 8,668,002/the winding rod 61 in U.S. Pat. No. 8,066,050. Thus they all have problems of difficulty in maintaining the horizontal position of the front fabric during rolling up or down. This is another main shortcoming of the prior art.

There is room for improvement and a need to provide a cordless Roman style shade that overcomes the above shortcomings by a front fabric being rolled-up or down under control of a rear fabric and at least one piece of middle fabric without the use of horizontal rods. The width of the rear fabric is equal to the width of the middle fabric.

### SUMMARY OF THE INVENTION

Therefore it is a primary object of the present invention to provide a cordless Roman style shade that includes at least one piece of middle fabric arranged between a front fabric and a rear fabric while the rear fabric and the middle fabric have the same width. A front end and a rear end of the middle fabric are connected to a rear side of the front fabric and the rear fabric respectively without the use of horizontal rods. Each piece of the middle fabric is retracted and wound around a rotating shaft in turn and the front fabric is also driven by the middle fabric to be retracted or extended gradually when the rear fabric is retracted and wound around the rotating shaft. Thus the front fabric is retracted or extended horizontally and evenly. The production cost of the cordless Roman style shade is reduced without the use of the horizontal rods.

In order to achieve the above object, a cordless Roman style shade according to the present invention includes a headrail with a certain width for installation on a window, a rotating shaft disposed under the headrail, a front fabric, a rear fabric and at least one piece of middle fabric arranged between the front fabric and the rear fabric. An upper end of the front fabric is fixed on a front side of the headrail so that a lower end of the front fabric is able to be suspended for shading the window. The width of the rear fabric is no more than that of the front fabric. An upper end of the rear fabric is fixed on the rotating shade so that a lower end of the rear fabric is able to be suspended and corresponding to the front fabric. The total length of the rear fabric suspended is preferred to be smaller than that of the front fabric suspended. The rear fabric is retracted upward or extended downward by the rotating shaft being rotated clockwise or counterclockwise. As to the middle fabric, its length is equal to the rear fabric. A front end of the middle fabric is horizontally connected to a position at a certain level of a rear side of the front fabric to form a connection portion. Thus the front fabric is divided into two adjacent front fabric segments by the connection portion at the certain level. There is no horizontal rod disposed on the connection portion at the certain level. A rear end of the middle fabric is horizontally connected to a position at a certain level of a front side of the rear fabric to form another connection portion. The rear end of the middle fabric is moved along with the rear fabric and wound around the rotating shaft when the rear fabric is retracted upward and wound around the rotating shaft. The front end of the middle fabric is also driven to move upward when the middle fabric is retracted along with the rear fabric. Thus each front fabric segment of the front fabric is foldably retracted or extended horizontally and evenly in turn by each connection portion.

The rotating shaft is used in combination with a spring member. The rotating shaft is rotated along with the rear fabric when the rear fabric is pulled downward to make the front fabric change from a foldably retracted state to an extended state. After the rear fabric in the extended state being released from the positioning state, the rotating shaft is rotated in the opposite direction due to restoring force of the spring member. Thus the front fabric and the rear fabric can be turned from the extended state to the retracted state.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing a rear view of an embodiment in an extended state according to the present invention;

FIG. 2 is a side view of the embodiment in the extended state in FIG. 1 according to the present invention;

FIG. 3 is a front view of the embodiment in the extended state in FIG. 1 according to the present invention;

FIG. 4 is an explosive view of the embodiment in the extended state in FIG. 1 according to the present invention;

FIG. 5 is partial enlarged view of the embodiment in the extended state in FIG. 1 according to the present invention.

### DETAILED DESCRIPTION OF THE PREFFERED EMBODIMENTS

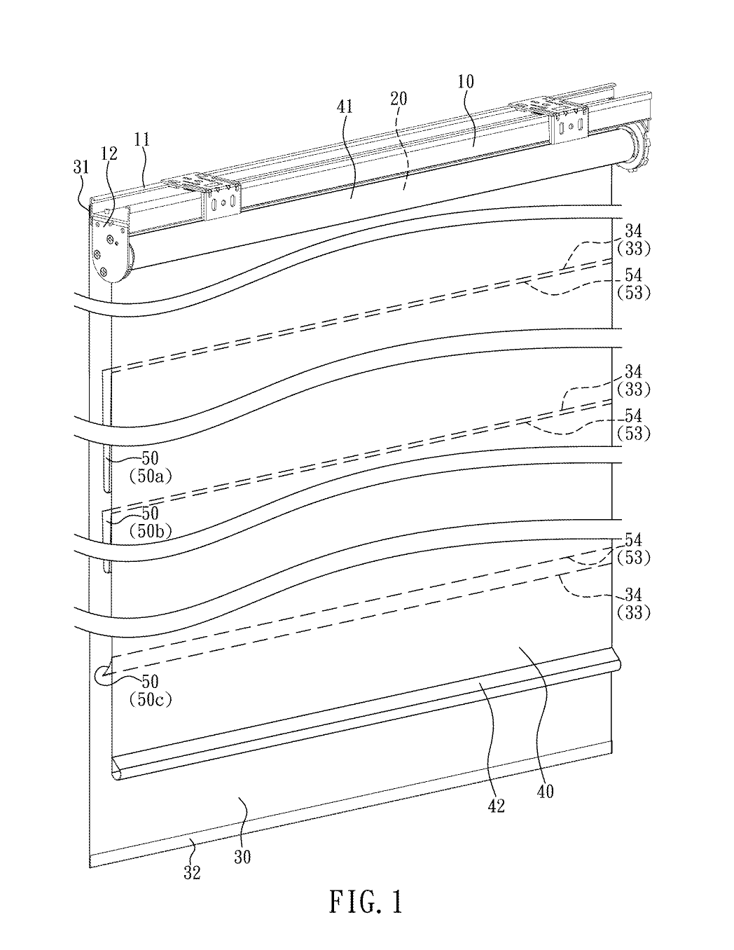

Refer to FIG. 1, a cordless Roman style shade of the present invention includes a headrail 10, a rotating shaft 20, a front fabric 30, a rear fabric 40 and at least one piece of middle fabric 50.

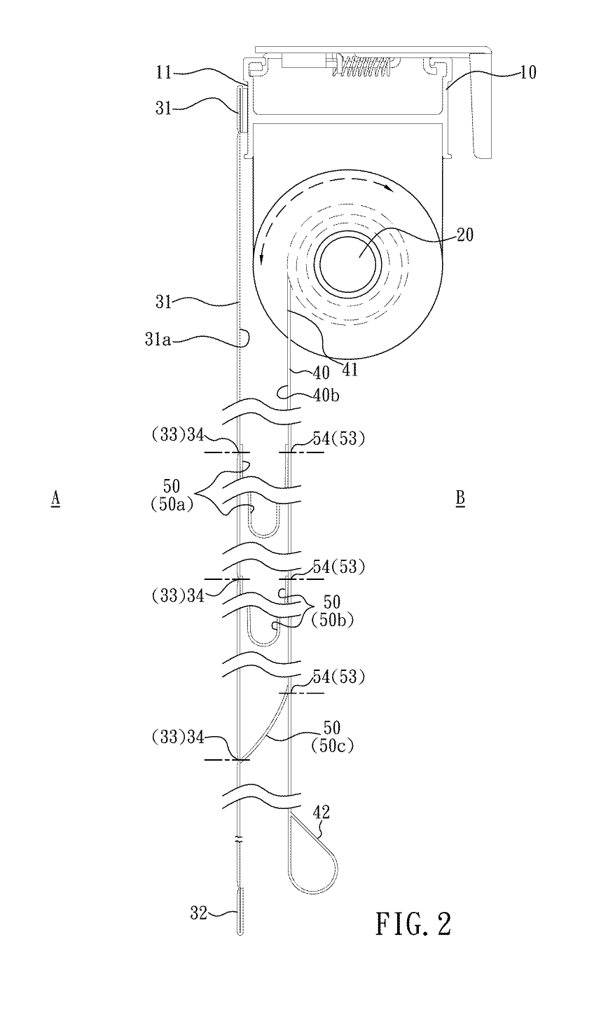

The headrail 10 with a certain width is used to be fixed on a window (now shown in figure). Thus the cordless Roman style shade of the present invention is used as a shade between indoor space A and indoor space B, as shown in FIG. 2.

Refer to FIG. 2, the rotating shaft 20 is disposed under the headrail 10. After installation of the cordless Roman style shade of the present invention, the front fabric 30 is located at the side close to the indoor space A and users in the indoor space A can see a front surface (front side) of the front fabric 30 while the rear fabric 40 is located at the side closed to the indoor space B. While in use, the users in the indoor space A will not see the rear fabric 40.

Refer to FIG. 2, an upper end 31 of the front fabric 30 is fixed on a front side 11 of the headrail 10 so that a lower end 32 of the front fabric 30 is able to be extended and suspended for shading the window completely.

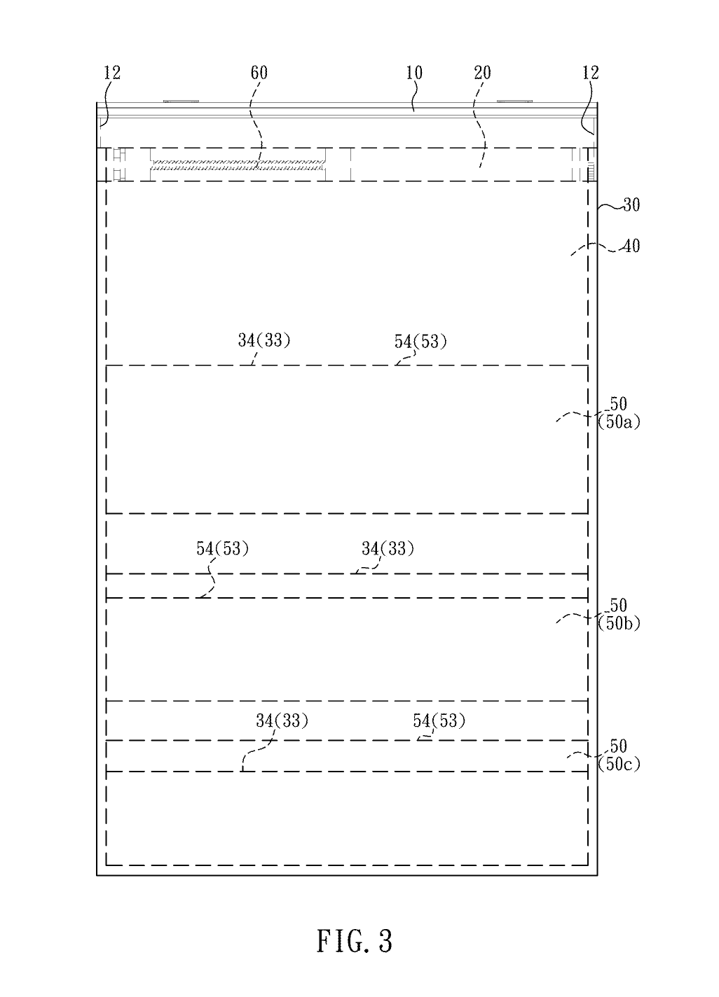

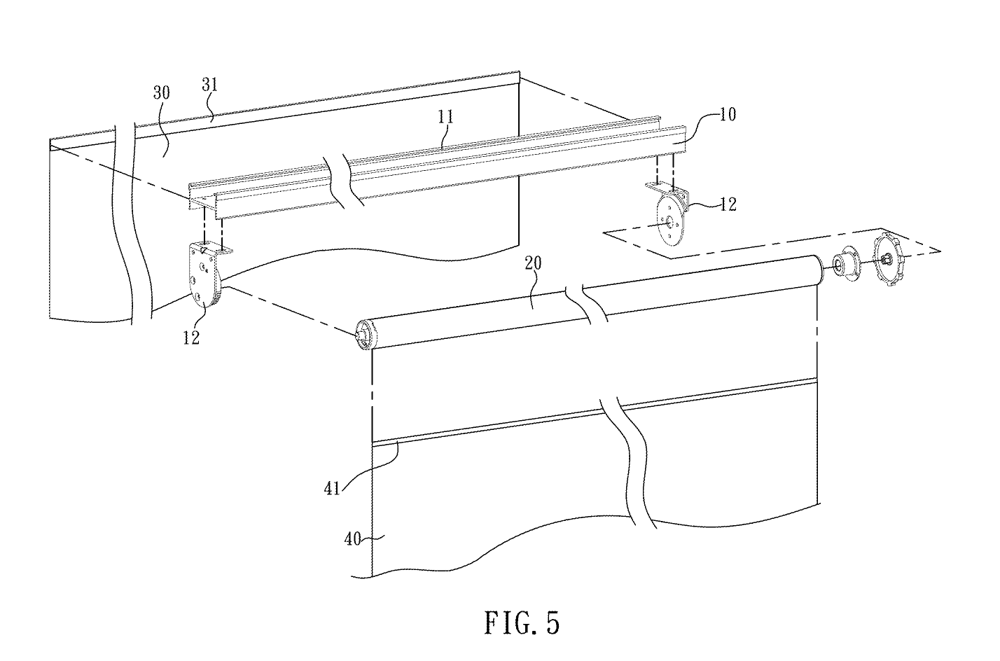

Still refer to FIG. 2, the width of the rear fabric 40 is no larger than that of the front fabric 30. An upper end 41 of the rear fabric 40 is fixed on the rotating shaft 20 so that a lower end 42 of the rear fabric 40 is able to be extended, suspended and corresponding to the front fabric 30. The total length of the rear fabric 40 suspended is preferred to be smaller than that of the front fabric 30 suspended. Thus users in the indoor space A will not see the rear fabric 40. While in use, the rear fabric 40 is retracted upward or extended downward by the rotating shaft 20 being rotated clockwise or counterclockwise. Refer to FIG. 3 and FIG. 5, the rotating shaft 20 is disposed on a bracket 12 under each side of the headrail 10. The bracket 12 under each side of the headrail 10 has a certain width so that the width of the rotating shaft 20 (the axial length) is equal to or a bit smaller than the width of the headrail 10 (the axial length). The upper end 31 of the front fabric 30 is fixed on the front side 11 of the headrail 10. Thus the width of the rear fabric 40 is no larger than that of the front fabric 30.

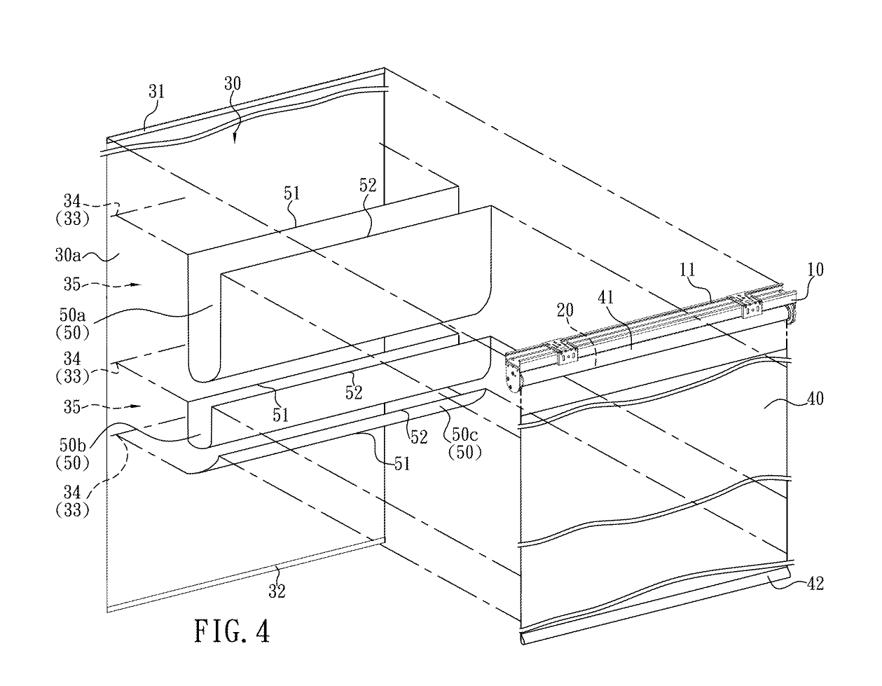

Refer from FIG. 1 to FIG. 5, the at least one piece of middle fabric 50 is arranged between the front fabric 30 and the area fabric 40. In this embodiment, there are three pieces of the middle fabric 50a, 50b, and 50c from top to bottom in turn. The width of each piece of the middle fabric 50 (50a, 50b, and 50c) is equal to that of the rear fabric 40. The width of each piece of the middle fabric 50 (50a, 50b, and 50c) and the width of the rear fabric 40 are both no larger than the width of the front fabric 30. As shown in FIG. 2 and FIG. 4, a front end 51 of each piece of the middle fabric 50 is horizontally connected to a position at a certain level 33 of a rear side 30a of the front fabric 30 to form a first connection portion 34. In this embodiment, the first connection portion 34 is formed by sewing, high frequency welding, mechanical adhesion, button/rivet fastening, etc without the use of the horizontal rod. Different from the prior arts (upper tubes 53 in U.S. Pat. No. 8,066,050 or support rod 311/312 in U.S. Pat. No. 8,668,002), the first connection portion 34 at different level 33 of the front fabric 30 of the present invention doesn't have any type of horizontal rod. The front fabric 30 is divided into two adjacent front fabric segments 35 by the first connection portion 34 at the level 33. Refer to FIG. 3 and FIG. 4, a rear end 52 of each piece of the middle fabric 50 is horizontally connected to a position at a certain level 53 at a front side 40b of the rear fabric 40 to form a second connection portion 54.

While in use, the rear end 52 of each piece of the middle fabric 50 (50a, 50b, and 50c) is moved along with the rear fabric 40 and wound around the rotating shaft 20 in turn when the rear fabric 40 is retracted upward and wound around the rotating shaft 20. The front end 51 of each piece of the middle fabric 50 (50a, 50b, and 50c) is also driven to move upward when the piece of the middle fabric 50 (50a, 50b, and 50c) is retracted along with the rear fabric 40. Thus each front fabric segment 35 of the front fabric 30 is foldably retracted or extended horizontally and evenly in turn by each first connection portion 34. The width of each piece of the middle fabric 50 (50a, 50b, and 50c) is equal to the rear fabric 40 so that both the rear fabric 40 and each piece of the middle fabric 50 (50a, 50b, and 50c) can be retracted and wound around the rotating shaft 20 evenly and horizontally. The cordless Roman style shade of the present invention do solve the uneven rolled-up/down problem of the prior arts mentioned above (U.S. Pat. No. 8,066,050, U.S. Pat. No. 8,668,002, etc.). Moreover, the production cost of the shade is reduced without the use of the horizontal rods arranged at the front fabric 30.

Furthermore, the height of the first connection portion 34 in relative to the second connection portion 54 of each piece of the middle fabric 50 (50a, 50b, and 50c) can be equal or unequal according to user's requirements. Take the embodiment in FIG. 3 as an example. The level 53 of the second connection portion 54 of the middle fabric 50a at the top of the cordless Roman style shade is equal to the level 33 of the first connection portion 34. The level 53 of the second connection portion 54 of the middle fabric 50b in the middle of the cordless Roman style shade is lower than the level 33 of the first connection portion 34. As to the middle fabric 50c at the bottom of the cordless Roman style shade, the level 53 of the second connection portion 54 is higher than the level 33 of the first connection portion 34. When there are at least two pieces of the middle fabric 50 (such as three pieces of the middle fabric 50 (50a, 50b, and 50c) in this embodiment), the level 33 of the first connection portion 34 at the front fabric 30 can be arranged at equal intervals or not. Thus the front fabric 30 can be foldably retracted and overlapped at the same position/or not. The front fabric 30 can be designed to have different retracted/folded patterns according to users' needs.

In addition, the rotating shaft 20 can be used in combination with a spring member 60, as shown in FIG. 3. The rotating shaft 20 is rotated along with the rear fabric 40 when the rear fabric 40 is pulled downward to make the front fabric 30 change from a foldably retracted state to an extended state, as shown in FIG. 1, FIG. 2 and FIG. 3. After the rear fabric 40 in the extended state being released from the positioning state, the rotating shaft 20 is rotated in the opposite direction due to restoring force of the spring member 60. Thus the front fabric 30 and the rear fabric 40 can be turned from the extended state to the retracted state (not shown in figures).

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A cordless Roman style shade comprising:
a headrail with a certain width for being installed on a window;
a rotating shaft disposed under the headrail;
a front fabric having an upper end thereof fixed on a front side of the headrail so that a lower end of the front fabric is able to be extended and suspended for shading the window;
a rear fabric, whose width is no more than a width of the front fabric, having an upper end fixed on the rotating shaft so that a lower end of the rear fabric is able to be extended and suspended corresponding to the front fabric; wherein the rear fabric is retracted or extended by the rotating shaft being rotated clockwise or counterclockwise; and
at least one piece of a middle fabric arranged between the front fabric and the rear fabric and having a width equal to the width of the rear fabric, a front end of each piece of middle fabric horizontally connected to a position at a level of a rear side of the front fabric to form a first connection portion, and a rear end of each piece of middle fabric horizontally connected to a position at a level of a front side of the rear fabric to form a second connection portion so as to fold the front fabric from the lower end up by retracting the rear fabric, and when the rear fabric is wound around the rotating shaft, the at least one piece of middle fabric is wound around the rotating shaft; wherein the front fabric is divided into two adjacent front fabric segments by the first connection portion;
wherein the rear end of the middle fabric is moved along with the rear fabric and wound around the rotating shaft when the rear fabric is retracted and wound around the rotating shaft for driving the front end of the middle fabric to move; thereby segments of the front fabric of the front fabric are foldably retracted or extended horizontally by the first connection portion; wherein each of the first connection portion of the front fabric is not connected with any horizontal rod; wherein the horizontal rod is made from rigid materials for supporting the front fabric and a width of the horizontal rod equal to the width of the first connection portion supporting the front fabric;
wherein when there are at least two pieces of the middle fabric arranged between the front fabric and the rear fabric from top to bottom, respectively, the length between the front end and the rear end of the upper piece of the middle fabric is longer than the length between the front end and the rear end of the lower piece of the middle fabric.

2. The device as claimed in claim 1, wherein the first connection portion and the second connection portion are formed by sewing, high frequency welding, mechanical adhesion.

3. (canceled)

4. (canceled)

5. (canceled)
